(19) United States
(12) Patent Application Publication
(10) Pub. No.: US 2008/0185931 A1
(43) Pub. Date: Aug. 7, 2008

(54) Asynchronous Electrical Machine With Tooth-Woud Coils in the Stator Winding System

(75) Inventors: Markus Platen, Bad Neustadt (DE); Detlef Potoradi, Bad Neustadat/Saale (Muhlbach) (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/911,393

(22) PCT Filed: Apr. 7, 2006
(86) PCT No.: PCT/EP2006/061448

§ 371 Date: Oct. 12, 2007

(30) Foreign Application Priority Data
Apr. 12, 2005 (DE) 10 2005 016 856.6

(51) Int. Cl. H02K 17/16; H02K 3/48

(52) U.S. Cl. 310/179; 310/211

(57) ABSTRACT

The invention relates to an electrical asynchronous machine comprising a stator and a rotor. The stator has a stator winding system comprising a plurality of toothed coils which are partially arranged in stator grooves. The rotor has a rotor winding system consisting of a plurality of short-circuited electrical lines arranged in the rotor grooves (7). The rotor comprises eleven, thirteen, seventeen or twenty-seven rotor grooves (7). In this way, losses caused by harmonic waves and torque ripple are reduced.

The invention relates to an asynchronous electrical machine having a stator and a rotor, a stator winding system comprising tooth-wound coils being provided.

DE 103 25 982 A1 describes a stator winding system which is realized using tooth-wound coils. It is also intended, inter alia, for use in an asynchronous electrical machine.

A stator winding system based on tooth-wound coils produces a comparatively high harmonic content in the electrical stator air gap field. These harmonics can, in the case of an asynchronous electrical machine, interact with the rotor air gap field and therefore result in undesirable side effects. In particular, severe scattering, high losses or ripple in the torque produced by the asynchronous machine may occur. This ripple is brought about by oscillation torques.

The object of the invention therefore consists in specifying an asynchronous electrical machine of the type mentioned at the outset in which the mentioned side effects are at least reduced despite the use of a stator winding system based on tooth-wound coils.

This object is achieved by the features of independent patent claim 1. The asynchronous electrical machine according to the invention is one in which
a) the stator comprises a stator winding system, which is formed by means of a plurality of tooth-wound coils, some of which are arranged in stator slots,
b) the rotor comprises a rotor winding system, which is formed by means of a plurality of short-circuited electrical conductors laid in rotor slots, and
c) the rotor has a number of rotor slots of eleven, thirteen, seventeen or twenty-seven.

Owing to the mentioned side effects, tooth-wound coils have until now virtually not been used for the construction of the stator winding system in asynchronous electrical machines. First the targeted selection, provided in accordance with the invention, of the slot number provided in the rotor, and therefore in particular also the number of electrical conductors arranged distributed over the circumference of the rotor, makes possible the very advantageous use in terms of manufacturing of tooth-wound coils in the stator winding system. When using eleven, thirteen, seventeen or twenty-seven rotor slots, the undesirable side effects now only occur to a very considerably reduced extent, if at all. In addition, by means of the tooth-wound coils a higher filling factor with the material of the electrical conductors and consequently a higher capacity utilization of the asynchronous electrical machine can be achieved.

Preferably, the electrical conductors are in the form of bars of copper or of aluminum. These materials have a favorable high electrical conductivity, with the result that the I²R losses in the rotor winding system are kept low.

The short circuit between the electrical conductors takes place in particular by means of correspondingly desired short-circuiting rings, which are arranged on both axial end sides of the rotor, with the result that the design of the rotor is one referred to as a short-circuiting rotor or squirrel-cage rotor.

Advantageous configurations of the asynchronous electrical machine according to the invention result from the features of the claims which are dependent on claim 1.

A favorable variant is one in which the stator winding system has a number of stator slots which is divisible by three. It is furthermore preferred that the stator winding system has a slot number of 0.5. As a result, in particular the formation of subharmonic wave components in the stator air gap field is largely avoided.

In accordance with another variant, the rotor slots have a web height of at least 3 mm. As a result, the interaction of harmonics of the rotor air gap field with the harmonic spectrum of the stator air gap field is at least considerably reduced.

This advantage is also provided by a further preferred configuration in which the rotor slots have a skew.

Further features, advantages and details of the invention result from the description below relating to exemplary embodiments with reference to the drawing, in which:

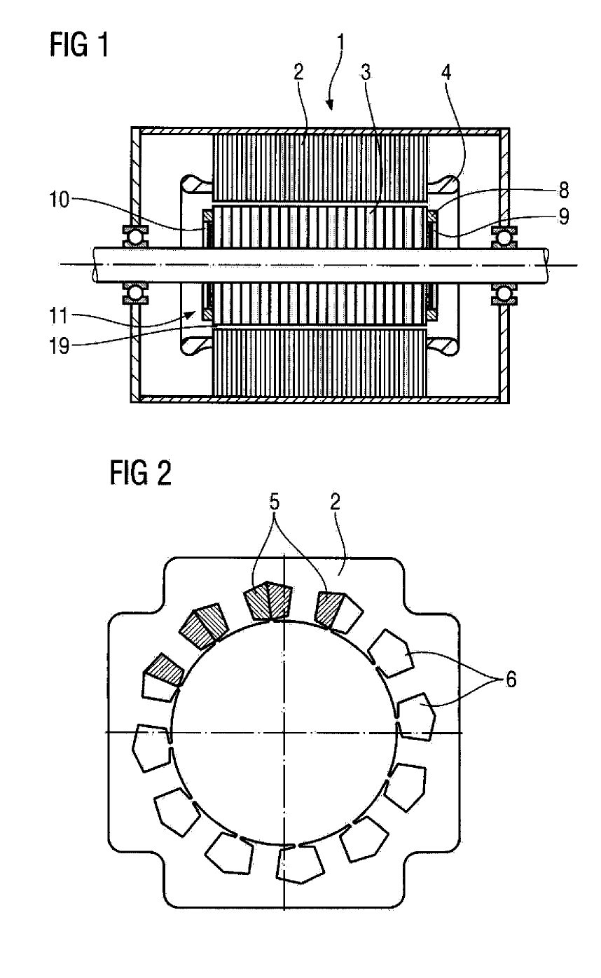

FIG. 1 shows an exemplary embodiment of an asynchronous electrical machine with tooth-wound coils in the stator and with a special rotor slot number, in an illustration of a longitudinal section,

FIG. 2 shows a cross section through the stator of the asynchronous electrical machine shown in FIG. 1, and

FIGS. 3 to 8 show a plurality of exemplary embodiments of a rotor laminate section inserted in the rotor of the asynchronous electrical machine shown in FIG. 1.

Mutually corresponding parts have been provided with the same reference symbols in FIGS. 1 to 8.

FIG. 1 shows an exemplary embodiment of an asynchronous electrical machine 1 having a stator 2 and a rotor 3, in an illustration of the longitudinal section. FIG. 2 reproduces a cross section through the stator 2. The stator 2 comprises a stator winding system 4 which is not illustrated in any more detail in FIG. 1 (apart from the end windings) and is realized by means of prefabricated tooth-wound coils 5. The individual conductor windings of said tooth-wound coils 5 run largely in stator slots 6 of a stator laminate stack.

In the exemplary embodiment, the stator winding system 4 is designed to have eight poles, i.e. a pole pair number of p=4. Furthermore, given a number of phases of m=3, a stator slot number of N1=12 is provided. The stator winding system 4 is therefore a fractional-slot winding with a slot number of q=N1/(2p·m)=½.

The rotor 3 comprises a rotor laminate stack having substantially axially running rotor slots 7, which are distributed uniformly over the circumference of the rotor 3 and into which electrically conductive copper bars 8 are inserted. The copper bars 8 are electrically conductively connected to one another on both axial end sides of the rotor 3 by means of a short-circuiting ring 9 and 10, respectively. A so-called squirrel-cage rotor is provided. The copper bars 8 and the two short-circuiting rings 9 and 10 form a rotor winding system 11.

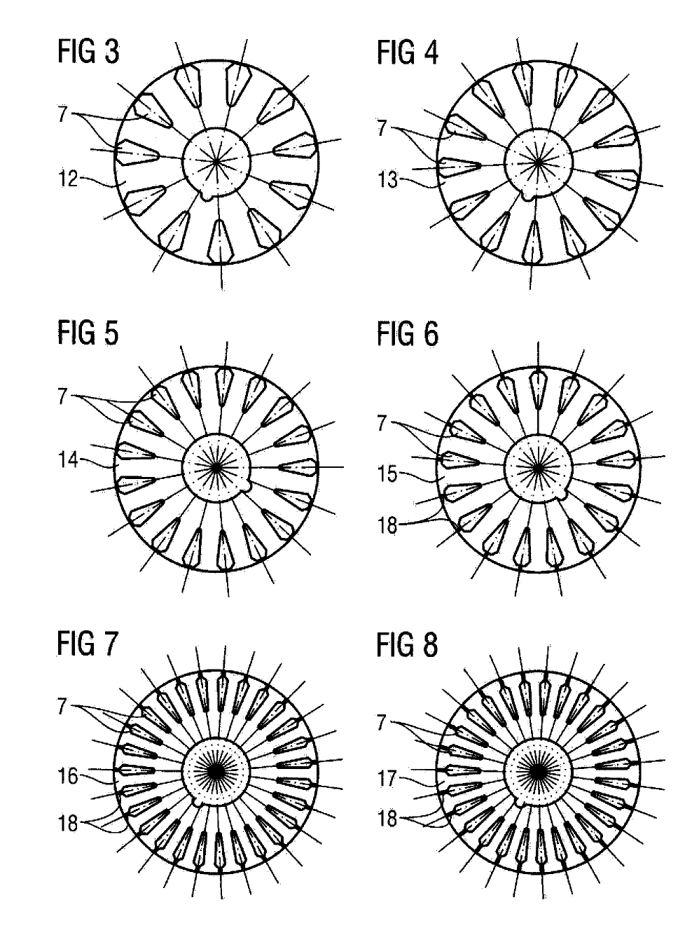

FIGS. 3 to 8 show exemplary embodiments of rotor laminate sections 12 to 17, which are used in the rotor laminate stack. These exemplary embodiments differ primarily by means of the respectively provided number N2 of rotor slots 7 and therefore also the copper bars 8 provided in the rotor winding system 11. The rotor slot number N2 in the case of the rotor laminate section 12 shown in FIG. 3 assumes the value 11, in the case of the rotor laminate section 13 shown in FIG. 4 assumes the value 13, in the case of the rotor laminate sections 14 and 15 shown in FIGS. 5 and 6, respectively, in each case assumes the value 17 and in the case of the rotor laminate sections 16 and 17 shown in FIGS. 7 and 8, respectively, in each case assumes the value 27. The rotor laminate sections 15 to 17, in contrast to the other three rotor laminate sections 12 to 14, each have a web height 18 which is different than zero. In the case of the rotor laminate sections 15 and 16, the web height 18 is in each case 3 mm, and in the case of the rotor laminate section 17, on the other hand, 5 mm.

Owing to the tooth-wound coils 5 used in the stator winding system 4, the stator air gap field forming in the air gap 19 between the stator 2 and the rotor 3 has a higher harmonic content than in the case of a conventional stator winding system, which is realized by means of distributed coil windings. In order to reduce or to completely suppress the undesirable oscillation torques forming otherwise, the rotor 3 is designed such that, in the event of little scattering, as little interaction as possible results between the rotor air gap field and the harmonics of the stator air gap field.

This is made possible by means of the abovementioned defined selection for the number N2 of rotor slots 7 provided in the rotor 3. Given the mentioned dimensions of the stator winding system 4 (i.e. q=½, N1=12 and m=3), the rotor laminate sections 12, 14 and 15 with a rotor slot number N2 of eleven or seventeen have proven particularly efficient in this regard. Low losses brought about by the harmonics and very low torque ripple result.

The web height 18 additionally provided in the case of the rotor laminate sections 15 to 17 which is different than zero minimizes the undesirable influence of the harmonics further. The same applies for an arrangement of the rotor slots 7 and therefore also of the copper bars 8 which is skewed in relation to the axis of rotation of the rotor 3.

Overall, despite the unusually low stator slot number N1 (in connection with the use of tooth-wound coils 5) of only twelve, a very good overall response of the asynchronous electrical machine 1 can be achieved. The low stator slot number N1 also allows for simple production, resulting in low manufacturing costs.

1.-5. (canceled)

6. An asynchronous electrical machine, comprising:
a stator comprising a stator winding system formed by a plurality of tooth-wound coils which are partly arranged in stator slots; and
a rotor comprising a rotor winding system formed by a plurality of short-circuited electrical conductors laid in rotor slots, wherein the rotor has rotor slots at a number selected from the group consisting of eleven, thirteen, seventeen, and twenty-seven.

7. The asynchronous machine of claim 6, wherein the stator winding system has a number of stator slots which is divisible by three.

8. The asynchronous machine of claim 6, wherein the stator winding system has a slot number of 0.5.

9. The asynchronous machine of claim 6, wherein the rotor slots have a web height of at least 3 mm.

10. The asynchronous machine of claim 6, wherein the rotor slots have a skew.
